(19) United States
(12) Patent Application Publication
(10) Pub. No.: US 2013/0124643 A1
(43) Pub. Date: May 16, 2013

(54) SYSTEM AND METHOD FOR COMMUNICATION THREAD MANAGEMENT

(71) Applicants: Lisa Seacat DeLuca, San Francisco, CA (US); Lydia M. Do, Raleigh, NC (US); Jenny S. Li, Danbury, CT (US)

(72) Inventors: Lisa Seacat DeLuca, San Francisco, CA (US); Lydia M. Do, Raleigh, NC (US); Jenny S. Li, Danbury, CT (US)

(73) Assignee: INTERNATIONAL BUSINESS MACHINES CORPORATION, Armonk, NY (US)

(21) Appl. No.: 13/294,367

(22) Filed: Nov. 11, 2011

(51) Int. Cl. G06F 15/16

(52) U.S. Cl. 709/206; 709/204

(57) ABSTRACT

Described are systems and methods for managing an electronic communication thread. A thread is identified between a first electronic device and a plurality of second electronic devices. A parameter is generated to stop watching communications generated by the second electronic devices related to the thread. At least one new communication from the second electronic devices is detected, the at least one new communication related to the thread. An action is performed in accordance with criteria established with respect to the thread in response to detecting the at least one new communication.

### FIELD OF THE INVENTION

The present invention relates generally to electronic communications, and more specifically to systems and methods for managing communication threads.

### BACKGROUND

Email is a well-known form of communication between computer users. A popular email feature permits a receiver of an electronic mail (email) message to respond to the email message by selecting a “reply all” button from the receiver's email client. In response, the email response is sent to each email address identified in the original email message, including the sender of the original email message. An email thread is formed from the original email message and the subsequent reply messages. As a thread expands due to the back-and-forth exchange of messages between the sender and the recipients, the contents of previous messages in the thread are typically included in chronological order in the body of each current message.

### BRIEF SUMMARY

In one aspect, a computer-implemented method is provided for managing an electronic communication thread. The method comprises identifying a thread between a first electronic device and a plurality of second electronic devices; generating a parameter to stop watching communications generated by the second electronic devices related to the thread; detecting at least one new communication from the second electronic devices, the at least one new communication related to the thread; and performing an action in accordance with criteria established with respect to the thread in response to detecting the at least one new communication.

In another aspect, a computer-implemented method is provided for managing an electronic communication thread. The method comprises identifying a thread between a first electronic device and a plurality of second electronic devices; sending from the first electronic device a communication to a plurality of second electronic devices, wherein the thread includes the communication; forming a communication watch list in response to generating the communication; receiving a first reply communication from a second electronic device of the plurality of electronic devices, the first reply communication related to the thread; preparing a first response to the first reply communication, the first response related to the thread; generating a response template from the first response; receiving a second reply communication subsequent to receiving the first reply communication, the second reply communication sent from another second electronic device of the plurality of second electronic devices, the second reply communication related to the thread; replying with the response template at the first electronic device in response to receiving the second reply communication; generating a second response from the response template, the second response related to the thread; and sending the second response to the other second electronic device.

In another aspect, a computer program product is provided for managing an electronic communication thread, the computer program product. The computer program product comprises a computer readable storage medium having computer readable program code embodied therewith. The computer readable program code comprises computer readable program code configured to identify a thread between a first electronic device and a plurality of second electronic devices; computer readable program code configured to generate a parameter to stop watching communications generated by the second electronic devices related to the thread; computer readable program code configured to detect at least one new communication from the second electronic devices, the at least one new communication related to the thread; and computer readable program code configured to perform an action in accordance with criteria established with respect to the thread in response to detecting the at least one new communication.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a diagram illustrating an email communication environment, in accordance with an embodiment;

FIG. 2 is a block diagram of the thread management system of FIG. 1, in accordance with an embodiment;

FIG. 3 is a flow diagram of a method for managing an email thread, in accordance with an embodiment; and

FIG. 4 is a diagram illustrating another method for managing an email thread, in accordance with an embodiment.

### DETAILED DESCRIPTION

In the following description, specific details are set forth although it should be appreciated by one of ordinary skill that the systems and methods can be practiced without at least some of the details. In some instances, known features or processes are not described in detail so as not to obscure the present invention.

An email thread can become unmanageable when an email thread is created by the sender outputting an email message to a large distribution list. Here, many of the recipients of the email message may respond to the email message, compelling the sender of the original email message to respond to each reply message. The thread can grow, or other threads can be generated, as other recipients join the exchange. This can be unproductive to the sender, who may feel obligated to reply to each message, or to recipients on the sender's reply all list who do not wish to participate in the exchange.

In brief overview, a system and method are provided to enabling a user of an email application or other online communication tool to select an appropriate action when multiple recipients reply to an original communication sent by the user. Unlike conventional approaches, the action can include automated responses to specific recipient reply messages.

In accordance with embodiments of the present inventive concepts, a thread management system and method are provided for managing reply messages that are part of a thread established by an original communication such as an email message. The thread management system is configured to intercept, or catch, reply messages in accordance with a set of predefined criteria, or rules. For example, the thread management system can be configured to distinguish a thread relating to a spam message from a thread relating to a congratulatory email, e.g., an email announcing an email sender's promotion. In this manner, reply messages that are part of the same thread as the original communication can be intercepted prior to being processed by the user's inbox, web browser, and the like.

The user, i.e., the target of the reply messages, can determine an appropriate action with respect to the intercepted reply messages. In a preferred embodiment, an automatic message is sent to the email recipient who sent the reply message. Alternatively, certain reply messages can be received by the user rather than being intercepted according to the predefined rules implemented at the thread management system. Factors determining whether reply messages are intercepted or passed through can include the relationship between the user and the recipient, the quality of the reply message, e.g., the length of the reply message or quality or quantity of the contents of the reply message, or the source of the reply message, e.g., the domain name, or other predetermined criteria.

In other embodiments, an editing tool is provided that automatically recognizes when an email response is similar to an earlier response sent as part of the same discussion thread. The editing tool can be configured to automatically suggest that the earlier response is used as a template for other email responses of the same thread. The editing tool can also recognize when an email response is of a different nature or context. For example, a previous response to a birthday party invitation may include a Happy Birthday greeting, while a subsequent email response may include a message asking if the sender can bring a cake to the party. Therefore, the two responses are treated differently despite both being responses from the same email thread.

Accordingly, an email user can control situations in which many reply messages are sent to the user referring to the same topic, for example, where spam is generated, or where an email message is sent to a large distribution list. In particular, an email user can control the number and type of email responses addressed to the user without the need for the user to read or otherwise process each email response. Another feature is that an email user can group anticipated email messages accordingly, for example, when receiving several email messages including the phrase “Happy Birthday.” Here, the email recipient can send an automatic reply to each computer sending the “Happy Birthday” message, for example, each message that is part of the same thread.

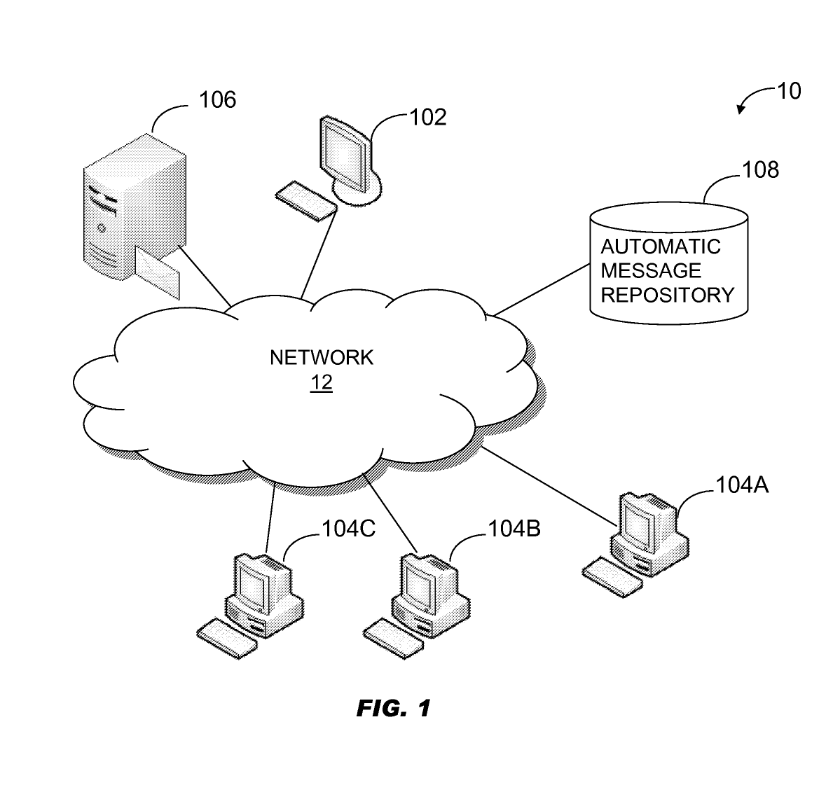

FIG. 1 is a diagram illustrating an email communication environment 10, in accordance with an embodiment. The environment 10 includes a first user computer 102, a plurality of second user computers 104A, 104B, 104C (generally, 104), a thread management system 106, and an automatic message repository 108 in communication with each other via a network 12. The user computers 102, 104 can be laptop computers, desktop computers, smartphones, or other electronic devices having a processor, a memory, and a network interface (NIC). Stored in the memory of a user computer 102, 104 can include an email application, a web browser, an instant messaging application, and/or other applications configured for exchanging electronic communications with other electronic devices.

A person at the first user computer 102 can send an electronic communication, for example, an email message, to one or more second user computers 104. Other forms of electronic communication can equally apply, for example, messages related to instant messaging (IM), bulletin boards, newsgroups, Internet forums, or other exchanges in which a conversation thread is established and where the messages can be grouped by a topic and the like, resulting in an hierarchy of discussions within the thread's topic. A person at the first user computer 102 can be referred to as a sender or originator, and the recipients at the second user computers 104 can be referred to as recipients or receivers. A person at a second user computer 104 can send a reply communication to the person at the first user computer 102. Here, the person at the second user computer 104 can be referred to as a sender or originator and the person at the first user computer 102 can be referred to as a recipient or a receiver.

An email thread can be formed when an email message is sent from the first user computer 102 to the recipient user computers 104, and at least one recipient at a second user computer 104 generates a reply email message. Any of the recipients at the second user computers 104 can respond to the thread, thereby keeping the thread active, or open. The email originator at the first user computer 102, in turn, can send a reply email message to the recipients at user computers 104, thereby expanding the thread. Other threads can be spawned from the original thread, for example, when a recipient at the second user computer 104A receives a thread email from the first user computer 102 and forwards it to the second user computer 104B.

The thread management system 106 provides the ability for the first user computer 102 to respond to individual threads by capturing thread emails sent by a second user computer 104 and complying with user-directed actions as to what to do with the captured thread emails. One action is that an automatic message can be sent to the second user computer 104 from which the reply email message is generated. Another action can be that the first user computer 102 receives reply messages directly from one or more user computers 104 according to a predetermined set of rules, for example, based on the relationship between the user and the recipient. The thread management system 106 can be part of a standalone computer, or configured as part of an email server, an application server, and the like.

The automatic message repository 108 stores messages that can be sent as automatic response messages to the second user computers 104 when reply messages are intercepted and determined to be part of a particular thread. The automatic message repository 108 can be accessed by an email editing tool for receiving template email messages, described herein.

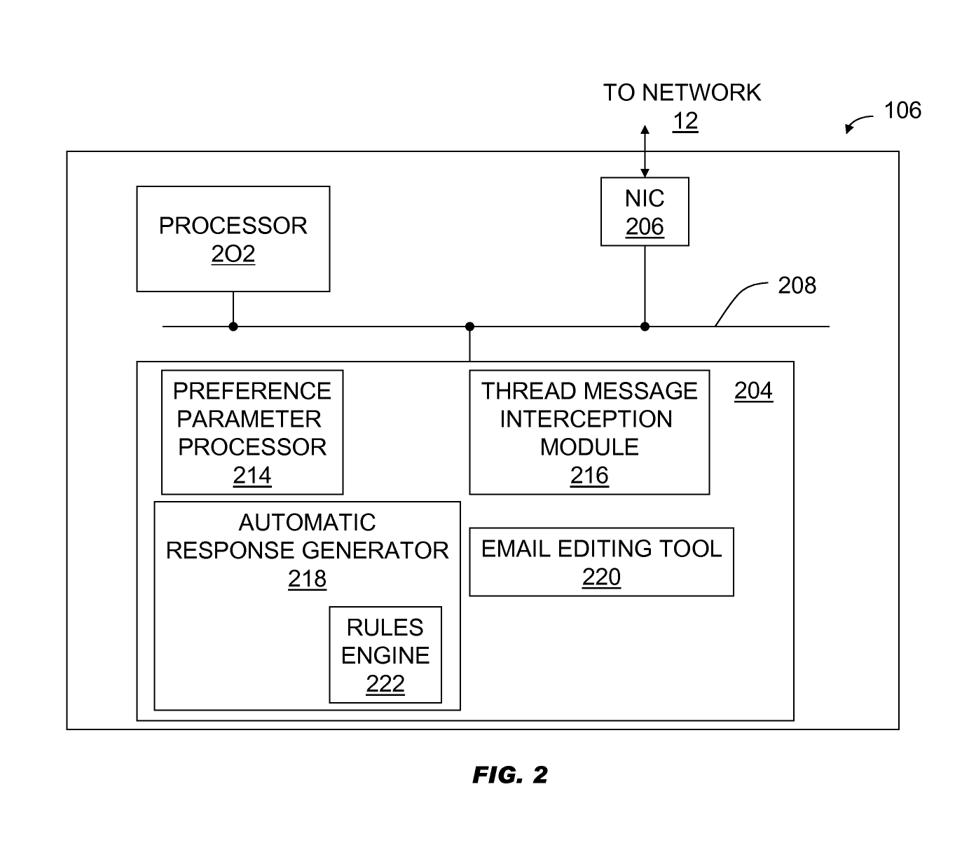

FIG. 2 is a block diagram of the thread management system 106 of FIG. 1, in accordance with an embodiment. The thread management system 106 includes a processor 202, a memory 204, and a network interface controller (NIC) 206, which can communicate with each other via a bus 208 and/or data connectors. The NIC 206 can include one or more adaptors for communicating with the first and second user computers 102, 104 via the network 12.

The memory 204 can include volatile memory, for example, RAM and the like, and/or non-volatile memory, for example, ROM, flash memory, and the like. The memory 204 can include removable and/or non-removable storage media implemented in accordance with methods and technologies known to those of ordinary skill in the art for storing data. Stored in the memory can include program code, such as program code of an operating system executed by the processor 202 and program code corresponding to elements of the thread management system 106, which includes a preference parameter processor 214, a thread message interception module 216, an automatic response generator 218, and/or an email editing tool 220.

Although the thread management system 106 is shown at FIG. 2 as being part of a common hardware platform, some or all of the elements of the thread management system 106 can be located at the first user computer 102, the second user computers 104, or other computers or servers of the email communication environment 10, for example, an email server (not shown). For example, the thread message interception module 216 can be co-located at the first user computer 102 with an email application, and can communicate with the other elements of the thread management system 106 via the network 12.

The thread management system 106 can also include a preference parameter generator (not shown) that is configured at the first user computer 102. The preference parameter generator permits a person at the first user computer 102 to generate a stop watching parameter that, when executed by the preference parameter processor 214, prevents the first user computer 102 from directly receiving email replies corresponding to a given thread. The preference parameter generator can generate the stop watching parameter, or related parameters, via a new user experience (UX) on an email client at the first user computer 102. Alternatively, the preference parameter generator can permit a user to generate parameters such as the stop watching parameter via a file menu option displayed at the first user computer 102. Other options can include the user activating the stop watching parameter by clicking with a mouse or other input device a link of the thread displayed at the email client, discussion board, and the like, or clicking a message in the thread at which the user wishes to activate the stop watching parameter.

The preference parameter generator can be configured to send preference parameters such as the stop watching parameter to the preference parameter processor 214, which instructs the thread management interception module 216 how to process an incoming email message. For example, the preference parameter generator can receive parameters that instruct the automatic response generator 218 to provide an automatic response to an incoming email message in accordance with a set of predetermined conditions.

Many applications offer a watch thread feature, which allows the user to receive email notifications specific to a particular topic, or thread, that is identified by the user for watching. The preference parameter processor 214, when receiving a stop watch request, prevents such email notifications from occurring. In this manner, the first user computer 102 can stop receiving messages on a given thread. Alternatively, the messages can be received in a manner that identifies the message as also being processed by the interception module 216, for example, received according to a color code, e.g. red, indicating that the message has been intercepted.

The messages are received at the thread message interception module 216, which determines whether the message is part of a particular thread. A reply message can be determined to be part of a thread according to certain criteria, for example, criteria related to a stop watching feature. Accordingly, the preference parameter processor 214 can process preferences, for example, from the preference parameter generator, which define user-specific “stop watching” parameters. For example, a preference parameter can establish that an email reply in a particular thread generated by a particular recipient, e.g., at the second user computer 104C, is to be sent directly to the first user computer 102, but all other replies to the same email thread from other recipients, e.g., at user computers 104A, 104B, are to be intercepted.

The automatic response generator 218 can receive a signal from the thread message interception module 216, which instructs the automatic response generator 218 to output an automatic message in response to a message that is part of a common thread. The automatic response generator 218 can include a rules engine 222 to establish the conditions under which an automatic message is generated. For example, the rules engine 222 can establish a time period during which a particular message is provided, or a time period in which different messages are provided. The rules engine 222 can establish a type of recipient at the second user computer 104 who can receive an automatic message. The rules engine 222 can establish where to send automatic email responses, for example, according to an email pattern. For example, the automatic response generator 218 can determine that some email replies corresponding to a thread are sent from a domain “@test.com”, while other email replies corresponding to the same thread are sent from “@company.com.” In this example, different automatic responses can be sent to email users at @test.com and @company.com, respectively.

Automatic messages can alternatively be generated according to keywords identified in the reply messages. For example, the automatic response generator 218 can determine that certain email responses corresponding to a thread includes the word “virus,” wherein the automatic response generator 218 outputs a first automatic message, while other email responses corresponding to the same thread include the phrase “windows registry update.” Here, the automatic response generator 218 outputs a second automatic message that is different than the first automatic message.

The automatic response generator 218 can receive automatic messages from a storage repository, for example, the automatic message repository 108, which can be located at a local repository, a server storing a group of available canned messages, or a file system.

The email editing tool 220 automatically recognizes when an email response is similar to an earlier response sent as part of the same discussion thread. The email editing tool 220 can be configured to automatically generate a message to a user who receives an email message that suggests that an earlier email generated by the user having the same thread can be used as a template for a response to this received email message.

The email editing tool 220 can eliminate the need for pre-configuring automatic messages, for example, writing email messages thanking email users for a Happy Birthday email in anticipation of receiving such messages, and storing the prerecorded response messages for automatically outputting the messages when the Happy Birthday emails are received. The editing tool 220 can be configured to automatically suggest that the earlier response be used as a template for other email responses of the same thread.

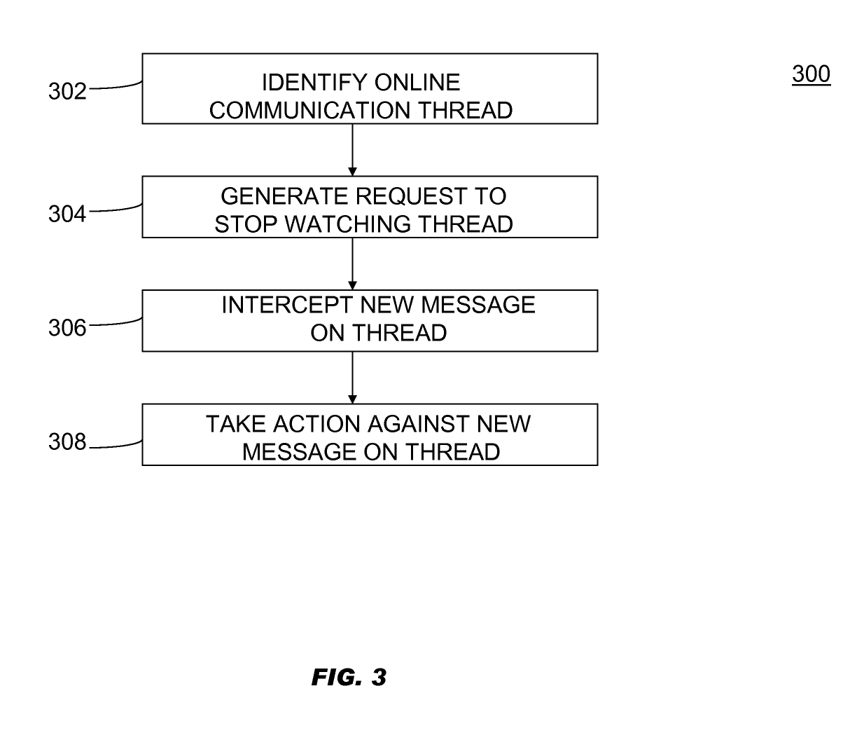

FIG. 3 is a flow diagram of a method 300 for managing an email thread, in accordance with an embodiment. In describing the method 300, reference is also made to elements of FIGS. 1 and 2. Some or all of the method 300 can be governed by instructions that are stored in a memory, e.g., memory 204 shown in FIG. 2, and can be executed by a processor, e.g., processor 202 of the thread management system 106 and/or user computers 102, 104 of FIGS. 1 and 2.

At block 302, an online communication thread is identified between a first user computer 102 and the second user computers 104. The thread can be formed at the first user computer 102, or it can be an existing thread, for example, formed by another party such as a user at a second user computer 104. The communication thread can be an email thread or other conversation thread. Although reference is frequently made to email messages, the method 300 can apply to other communications.

The sender at the first user computer 102 can establish that the thread is not to be watched. Accordingly, at block 304, the user computer 102 generates a stop watching request with respect to the online communication thread, indicating that the sender does not wish to receive reply messages. The request can be generated from a UX, a file menu option, activating the thread, and the like. The stop watching request can be alternatively configured so that reply messages are archived, deleted, tagged, labeled, or redirected to another destination.

The first user computer 102 can output other preference information to establish the actions to take when the stop watching parameter is executed. For example, preference information can establish which email messages of a given thread are to be intercepted and which email are to be sent directly to the first user computer 102. For example, the preference information can establish that email replies from family members are to be sent directly to the first user computer 102. In another example, a preference can establish that if an email thread extends beyond a predetermined period of time, e.g., a predetermined number of days, then responses received after the predetermined period of time are to be sent directly to the email user, and not intercepted. In another example, an action can be established in response to a stop watching event that received messages are to be marked as read by the email user 102, even though such messages were intercepted. In another example, an action can be established in response to a stop watching event that intercepted messages are to be archived or deleted. The user can deactivate the stop watching parameter and resume monitoring thread-related traffic from the first user computer 102 at any time, for example, using a UX.

At block 306, a new message is intercepted, for example, by the thread management system 106. The new message can be a reply message to an email message or related communication. The new message can be a message that is similar to other messages sent to the first user computer 102, for example, messages having a common thread, or topic or theme, such as a happy birthday greeting. At block 308, the thread management system 106 can perform an action according to the preferences, criteria, or rules established with respect to the identified thread. For example, optional preferences related to the stop watching parameter can be applied to the new message to determine an appropriate action.

An action can include generating an automatic message response to the originator of the new message. For example, when a recipient at a second user computer 104 sends an email message to the first user computer 102, the message can be intercepted by the thread management system 106, which, in response, outputs an automatic message to the second user computer 104. The action can include sending the new message directly to the intended recipient, e.g., user computer 102, where it can appear in the inbox of an email client executed at the user computer 102.

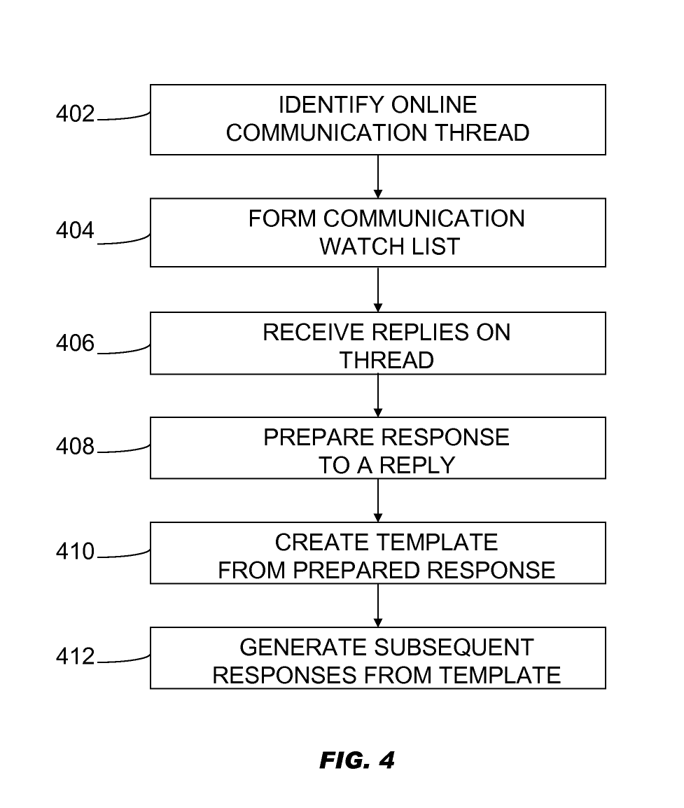

FIG. 4 is a diagram illustrating another method 400 for managing an email thread, in accordance with an embodiment. In describing the method 400, reference is also made to elements of FIGS. 1-3. Some or all of the method 400 can be governed by instructions that are stored in a memory, e.g., memory 204 shown in FIG. 2, and can be executed by a processor, e.g., processor 202 of the thread management system 106 and/or user computers 102, 104 of FIGS. 1 and 2.

At block 402, an online communication thread is identified. The communication thread can be an email thread or other conversation thread. Although reference is frequently made to email messages, the method 400 can apply to other communications.

At block 404, a communication watch list is formed. The thread management system 106 can identify an email message or related communication output from the first user computer 102 by the number of intended recipients. The number of intended recipients is predefined, and can be stored as a threshold value at the thread management system 106 that will trigger the system to alert the user of a potential email thread worth identifying as “stop watching”. Thus, when the thread management system 106 is informed that an email message has been output, the thread management system 106 can compare the actual number of intended recipients in the email message to the threshold value and “flag” the email message when the actual number of intended recipients exceeds the threshold value.

At block 406, at least one reply is received at the first user computer 102. The replies are preferably part of the same online communication thread as the original communication generated at block 402.

At block 408, the user at the first user computer 102 can prepare a response to one of the replies, for example, a first received reply. Alternatively, the response can be prepared before receiving a reply. Here, block 408 is performed before block 406.

At block 410, a template is created at the thread management system 106 from the prepared response. The template can be automatically created when the user sends the response to the intended recipient who sent the reply message. In other embodiments, the template is created prior to receiving the first reply. Alternatively, the user can select a button, field, and the like to generate the template. The user can review or modify the contents of the message and confirm the message as a template. The user can be given an option to save the template for a predetermined period of time, or under other criteria similar to those described herein. The template can be stored in the automatic message repository 108, or the user computer 102, or other storage device.

At block 412, subsequent responses can be generated from the template. The user can start to respond to a message that is part of a same thread. In doing so, the template can be generated at the first user computer 102 for the user to modify or send without modification as the response to subsequently received messages, for example, reply messages to an email thread. The template can be displayed at the first electronic device to confirm sending, or the template can be automatically populated with pre-defined messages and sent without confirmation. The thread management system 106 can automatically respond to future responders with the same message formed from the template, i.e., without user intervention.

In a related embodiment, different templates can be generated based on the context of the reply messages. For example, a user sends a birthday invitation to a group of email recipients. A first user responds with a reply message that includes the phrase “Happy Birthday.” An automatic response can be created that includes the phrase “thank you.” As described above, a subsequent reply from a second user that include the phrase “Happy Birthday” can receive automatic messages based on a first template configured to generate the “thank you” message.

In this embodiment, a third user can respond with a different message than “Happy Birthday” but is nevertheless related to the Happy Birthday thread, albeit relates to a different context. For example, the third user can send a reply message “Can I bring anything to your birthday party?” Since this message does not include the phrase “Happy Birthday,” the first template is not used to send an automatic reply message. However, the first user can receive an alert regarding the reply message from the third user. A second template can be generated in a similar manner as the first template. For example, the second template can automatically send a message “No need to bring anything” to the third user, or in response to similar reply messages including similar requests.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific embodiments, it should be understood by those skilled in the art that various changes in form and detail may be made therein without departing from the spirit and scope of the invention.

What is claimed is:

1. A computer-implemented method for managing an electronic communication thread, comprising:
identifying a thread between a first electronic device and a plurality of second electronic devices;
generating a parameter to stop watching communications generated by the second electronic devices related to the thread;
detecting at least one new communication from the second electronic devices, the at least one new communication related to the thread; and
performing an action in accordance with criteria established with respect to the thread in response to detecting the at least one new communication.

2. The computer-implemented method of claim 1, wherein the original communication and the at least one new communication includes email messages.

3. The computer-implemented method of claim 1, further comprising:
forming a communication watch list in response to generating the original communication;
preparing a first response to a first reply communication of the at least one new communication, the first reply communication sent from a second electronic device of the plurality of second electronic devices;
generating a response template;
receiving a second reply communication subsequent to receiving the first reply communication, the second reply communication sent from another second electronic device of the plurality of second electronic devices; and
replying with the response template at the first electronic device in response to receiving the second reply communication.

4. The computer-implemented method of claim 3, further comprising:
receiving a third reply communication that includes a different context than a context of the first and second reply communications; and
sending an alert to the first electronic device or automatically replying to the third reply communication with another response template based on the different context of the third reply communication.

5. The computer-implemented method of claim 1, wherein the action includes at least one of automatically generating a response to the at least one new communication, displaying the new communication, hiding the new communication, and displaying the grouped communications as a digest email, marking the new communication as read, labeling the new communication, tagging the new communication, archiving the new communication, and deleting the new communication.

6. The computer-implemented method of claim 5, wherein the action includes identifying a recipient of the original communication to determine whether to intercept a new communication of the at least one new communication or to direct the new communication of the at least one new communication sent by the recipient.

7. The computer-implemented method of claim 5, wherein the automatically generated response is output only to second electronic devices of the plurality of second electronic devices that sent the at least one new communication as part of the thread.

8. The computer-implemented method of claim 5, wherein the automatically generated response is generated according to a set of user-defined criteria.

9. The computer-implemented method of claim 8, wherein the user-defined criteria relate to a time period during which the at least one new communication is provided, a time period during which different reply communications are provided, a type of recipient for receiving the automatically generated response, a destination address or domain name for receiving the automatically generated response, an email pattern, or keywords identified in the contents of the at least one new communication, or a combination thereof.

10. The computer-implemented method of claim 1, further comprising:
receiving a preference;
establishing criteria corresponding to the preference for the at least one new communication to satisfy to determine whether the at least one new communication is part of the thread.

11. The computer-implemented method of claim 10, wherein the criteria includes whether a sender of the new communication is a member of a predetermined user list or whether the new communication is sent at a time that is within a predetermined time limit.

12. A computer-implemented method for managing an electronic communication thread, comprising:
identifying a thread between a first electronic device and a plurality of second electronic devices;
sending from the first electronic device a communication to a plurality of second electronic devices, wherein the thread includes the communication;
forming a communication watch list in response to generating the communication;
receiving a first reply communication from a second electronic device of the plurality of electronic devices, the first reply communication related to the thread;
preparing a first response to the first reply communication, the first response related to the thread;
generating a response template from the first response;
receiving a second reply communication subsequent to receiving the first reply communication, the second reply communication sent from another second electronic device of the plurality of second electronic devices, the second reply communication related to the thread;
replying with the response template at the first electronic device in response to receiving the second reply communication;
generating a second response from the response template, the second response related to the thread; and
sending the second response to the other second electronic device.

13. The computer-implemented method of claim 12, wherein the original communication and the first reply communication includes email messages.

14. The computer-implemented method of claim 12, further comprising:
receiving a third reply communication that includes a different context than a context of the first and second reply communications; and
sending an alert to the first electronic device or automatically replying to the third reply communication with another response template based on the different context of the third reply communication.

15. A computer program product for managing an electronic communication thread, the computer program product comprising:
a computer readable storage medium having computer readable program code embodied therewith, the computer readable program code comprising;
computer readable program code configured to identify a thread between a first electronic device and a plurality of second electronic devices;
computer readable program code configured to generate a parameter to stop watching communications generated by the second electronic devices related to the thread;
computer readable program code configured to detect at least one new communication from the second electronic devices, the at least one new communication related to the thread; and
computer readable program code configured to perform an action in accordance with criteria established with respect to the thread in response to detecting the at least one new communication.
